(19) United States
(12) Patent Application Publication
(10) Pub. No.: US 2020/0118736 A1
(43) Pub. Date: Apr. 16, 2020

(54) BOBBIN POSTS TO ASSEMBLE A SOLENOID

(71) Applicant: BorgWarner Inc., Auburn Hills, MI (US)

(72) Inventors: Chandreshwar Rao, Lake Orion, MI (US); Garrett R. Holmes, Lake Orion, MI (US)

(21) Appl. No.: 16/159,248

(22) Filed: Oct. 12, 2018

(51) Int. Cl. H01F 27/32; F16K 31/06; H01F 5/02; H01F 27/26; H01F 27/30

(52) U.S. Cl. CPC H01F 27/325; F16K 31/0675; H01F 27/306; H01F 27/263; H01F 5/02

(57) ABSTRACT

A solenoid valve includes a valve body extending along an axis between a first end and a second end and defining a fluid passage, a valve member disposed at least partially in the fluid passage, and a solenoid actuator coupled to the valve body. The solenoid actuator includes a flux core having a proximal core end adjacent to the valve body and a distal core end spaced from the proximal core end. At least one of the proximal and distal core ends defining a bore. The solenoid actuator also includes a bobbin extending along the axis and having a proximal bobbin end adjacent to the valve body and a distal bobbin end spaced from the proximal bobbin end, and at least one protrusion extending from at least one of the proximal and distal bobbin ends of the bobbin and through the bore to couple the bobbin to the flux core.

### BACKGROUND OF THE INVENTION

### 1. Field of the Invention

The present invention generally relates to a solenoid valve used in a transmission and, more specifically, to a solenoid actuator for the solenoid valve.

### 2. Description of the Related Art

Conventional vehicles known in the art typically include an engine having a rotational output as a rotational input into a transmission such as an automatic transmission. The engine generates the rotational output which is selectively translated to the transmission which, in turn, translates rotational torque to one or more wheels of the vehicle. The transmission changes the rotational speed and torque generated by the engine through a series of predetermined gearsets, whereby changing between the gearsets enables the vehicle to travel at different vehicle speeds for a given engine speed.

Automatic transmissions are typically controlled using hydraulic fluid and a hydraulic system including a pump assembly, a valve housing having one or more solenoid valves, and an electronic controller. The pump assembly provides a source of fluid power to the solenoid valves of the valve housing which, in turn, are actuated by the electronic controller so as to selectively direct hydraulic fluid throughout the automatic transmission to control modulation of the rotational torque generated by the rotational output of the engine. The solenoid valves are also typically used to change between the gear sets of the automatic transmission, and may also be used to control hydraulic fluid used to cool and/or lubricate various components of the transmission in operation.

The solenoid valves known in the art are often difficult to assemble. In particular, the solenoid valves comprise a solenoid actuator which typically requires time consuming and costly crimping processes to manufacture and assemble. Additionally, the components in the solenoid actuator often require precise tolerances to assemble the solenoid actuator. These tolerances compound for each component and accumulate to detrimentally “stack up”, thus achieving undesirable variances in the solenoid valves.

Accordingly, it is desirable to provide an improved solenoid actuator for a solenoid valve.

### SUMMARY OF THE INVENTION AND ADVANTAGES

The present invention provides a solenoid valve including a valve body extending along an axis between a first end and a second end spaced from the first end along the axis and defining a fluid passage, a valve member disposed at least partially in the fluid passage for controlling a flow of hydraulic fluid, and a solenoid actuator extending along the axis and coupled to the valve body.

The solenoid actuator includes a flux core extending along the axis, with the flux core having a proximal core end adjacent to the valve body and a distal core end spaced from the proximal core end along the axis such that the proximal core end is disposed between the valve body and the distal core end along the axis. At least one of the proximal and distal core ends defines a bore.

The solenoid actuator further includes a bobbin extending along the axis such that the flux core is disposed between the axis and the bobbin, with the bobbin having a proximal bobbin end adjacent to the valve body and a distal bobbin end spaced from the proximal bobbin end along the axis such that the proximal bobbin end is disposed between the valve body and the distal bobbin end along the axis. The solenoid actuator further includes at least one protrusion extending from at least one of the proximal and distal bobbin ends of the bobbin and through the bore to couple the bobbin to the flux core.

Accordingly, the at least one protrusion allows the bobbin and the flux core to be coupled to one another, which allows quicker and more efficient assembly of the solenoid valve. Another advantage of the present invention is that the tolerances of the components in the solenoid valve may be lowered without adversely affecting variances of the solenoid valve.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front view of the solenoid valve including a valve body extending along an axis between a first end and a second end, and including a solenoid actuator extending along the axis and coupled to the valve body;

FIG. 2A is a cross-sectional view of one embodiment of the solenoid valve depicted in FIG. 1, with the solenoid actuator including a flux core having proximal and distal core ends defining a bore, with the solenoid actuator including a bobbin having proximal and distal bobbin ends and at least one protrusion extending from the proximal and distal bobbin ends of the bobbin through the bore to couple the bobbin to the flux core;

FIG. 2B is a cross-sectional view of another embodiment of the solenoid valve depicted in FIG. 1, with the flux core including a base portion and a flux washer discrete from the base portion and defining the bore, with the valve body having a valve flange and defining a valve bore, and with the at least one protrusion extending through the valve bore of the valve body to couple the bobbin to the valve body;

FIG. 3 is an exploded view of the solenoid valve depicted in FIG. 2B, with the at least one distal protrusion extending through the bore of the flux washer, with an interference fit established between a first portion of the flux washer and a housing, and with a second portion of the flux washer and the housing define a gap therebetween;

FIG. 4A is a front view of the solenoid actuator shown partly in cross-section, with the distal core end of the flux core defining a bore and with the at least one protrusion further defined as an at least one distal protrusion extending from the distal bobbin end;

FIG. 4B is a front view of the solenoid actuator shown partly in cross-section, with the proximal core end of the flux core defining a bore and with the at least one protrusion further defined as an at least one proximal protrusion extending from the proximal bobbin end;

FIG. 4C is a front view of the solenoid actuator shown partly in cross-section, with the solenoid actuator including both the at least one distal protrusion and the at least one proximal protrusion;

FIG. 5 is a perspective view of the bobbin, the flux washer, and the coil surrounding the bobbin, and with the at least one protrusion further defined as an at least one post having a substantially cylindrical configuration;

FIG. 6A is an exploded view of the bobbin and the flux washer, with the bobbin having a single distal protrusion extending from a distal shoulder portion of the bobbin, and with the bobbin having a single proximal protrusion extending from a proximal shoulder portion of the bobbin;

FIG. 6B is an exploded view of the bobbin and the flux washer, with two distal protrusions extending from the distal shoulder portion of the bobbin and equally spaced circumferentially about the axis, and with two proximal protrusions extending from the proximal shoulder portion of the bobbin and equally spaced circumferentially about the axis;

FIG. 6C is an exploded view of the bobbin and the flux washer, with three distal protrusions extending from the distal shoulder portion of the bobbin and equally spaced circumferentially about the axis, and with three proximal protrusions extending from the proximal shoulder portion of the bobbin and equally spaced circumferentially about the axis;

FIG. 6D is an exploded view of the bobbin and the flux washer, with four distal protrusions extending from the distal shoulder portion of the bobbin and equally spaced circumferentially about the axis, and with four proximal protrusions extending from the proximal shoulder portion of the bobbin and equally spaced circumferentially about the axis;

FIG. 7A is a flowchart of a method of forming the solenoid actuator for the solenoid valve including the steps of inserting the bobbin around the flux core such that the flux core is disposed between the axis and the bobbin, with the bobbin having the proximal bobbin end and the distal bobbin end spaced from the proximal bobbin end along the axis, inserting the at least one protrusion into the bore of the flux core, and staking the at least one protrusion to couple the bobbin to the flux core;

FIG. 7B is a flowchart of the method of FIG. 7A, wherein the step of staking the at least one protrusion includes heat staking the at least one protrusion to couple the bobbin to the flux core;

FIG. 7C is a flowchart of the method of FIG. 7A, wherein the step of staking the at least one protrusion includes ultrasonically welding the at least one protrusion to couple the bobbin to the flux core; and

FIG. 7D is a flowchart of the method of FIG. 7A, further including the step of press-fitting the housing with at least one of the proximal and distal core ends such that an interference fit is established between the flux core and the housing at the at least one of the proximal and distal core ends.

### DETAILED DESCRIPTION OF THE INVENTION

With reference to the Figures, wherein like numerals indicate like parts throughout the several views, a solenoid valve 10 is shown for use in conjunction with an automatic transmission for a vehicle having an engine that cooperates with the automatic transmission. The engine generates rotational torque which is selectively translated to the automatic transmission which, in turn, translates rotational torque to one or more wheels of the vehicle. It should be appreciated that the engine and/or automatic transmission could be of any suitable type, configured in any suitable way sufficient to generate and translate rotational torque so as to drive the vehicle, without departing from the scope of the present invention. It should also be appreciated that the solenoid valve 10 may be used in another system such as in a transfer case, a locking differential, or a disconnect clutch in a hybrid drivetrain. It should further be appreciated that the solenoid valve 10 may be used in other applications where it is necessary to modulate the engagement of a system and then leave the system engaged for a period of time.

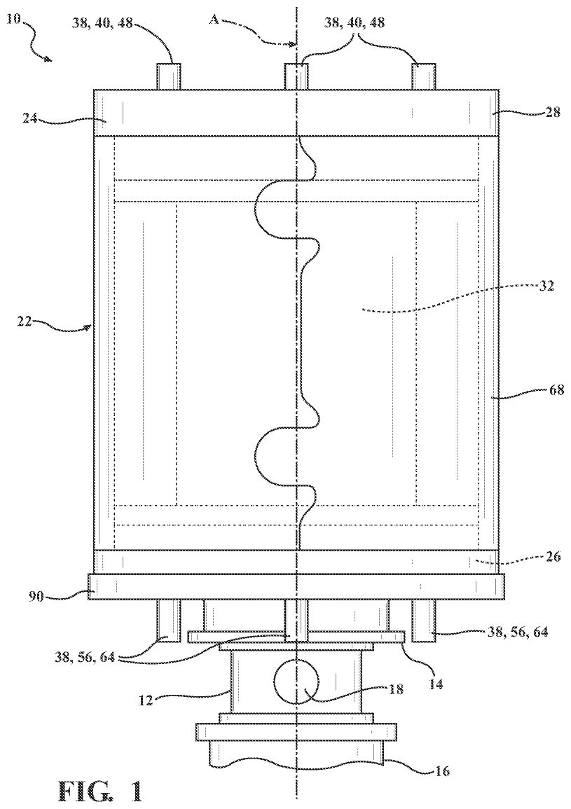

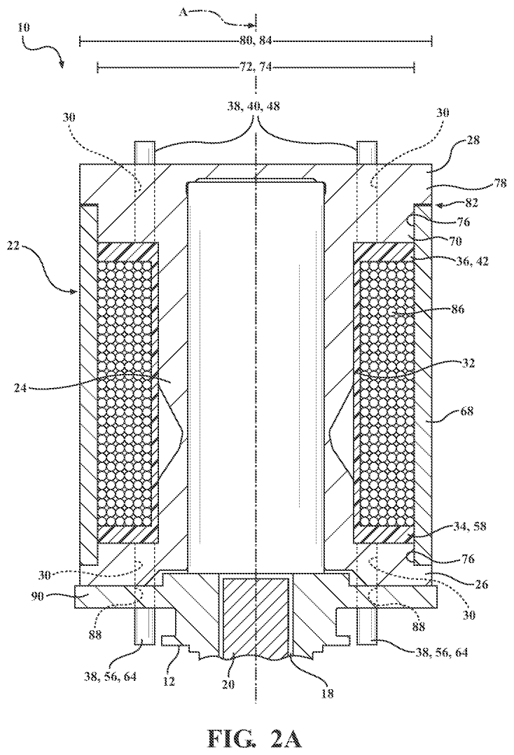

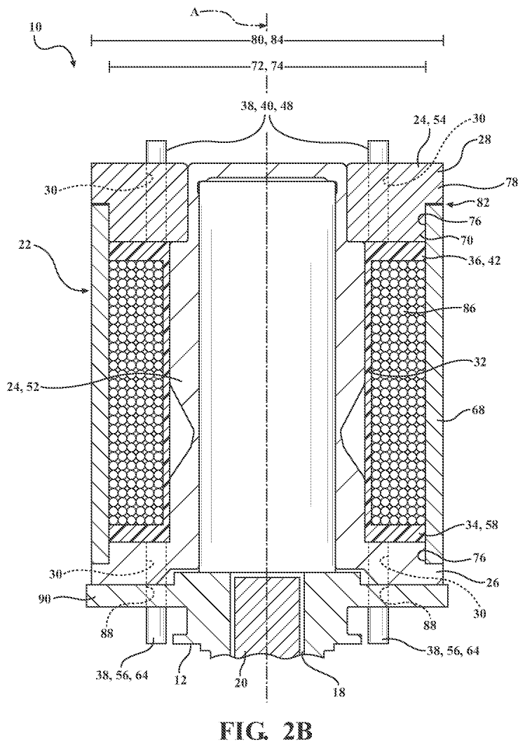

In one embodiment illustrated in FIG. 1, the solenoid valve 10 includes a valve body 12 extending along an axis A between a first end 14 and a second end 16 spaced from the first end 14 along the axis A and defining a fluid passage 18. As shown in FIGS. 2A and 2B, a valve member 20 is disposed at least partially in the fluid passage 18 for controlling a flow of hydraulic fluid, and a solenoid actuator 22 extends along the axis A and is coupled to the valve body 12.

As shown in FIGS. 2A and 2B, the solenoid actuator 22 comprises a flux core 24 extending along the axis A, with the flux core 24 having a proximal core end 26 adjacent to the valve body 12 and a distal core end 28 spaced from the proximal core end 26 along the axis A such that the proximal core end 26 is disposed between the valve body 12 and the distal core end 28 along the axis A. At least one of the proximal and distal core ends 26, 28 defines a bore 30. The solenoid actuator 22 further comprises a bobbin 32 extending along the axis A such that the flux core 24 is disposed between the axis A and the bobbin 32, with the bobbin 32 having a proximal bobbin end 34 adjacent to the valve body 12 and a distal bobbin end 36 spaced from the proximal bobbin end 34 along the axis A such that the proximal bobbin end 34 is disposed between the valve body 12 and the distal bobbin end 36 along the axis A.

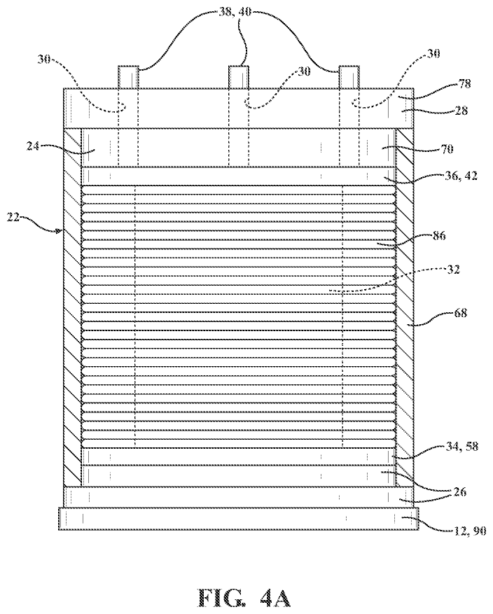

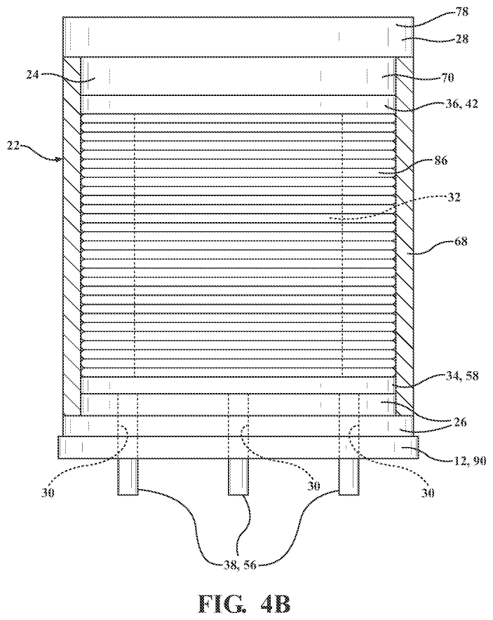

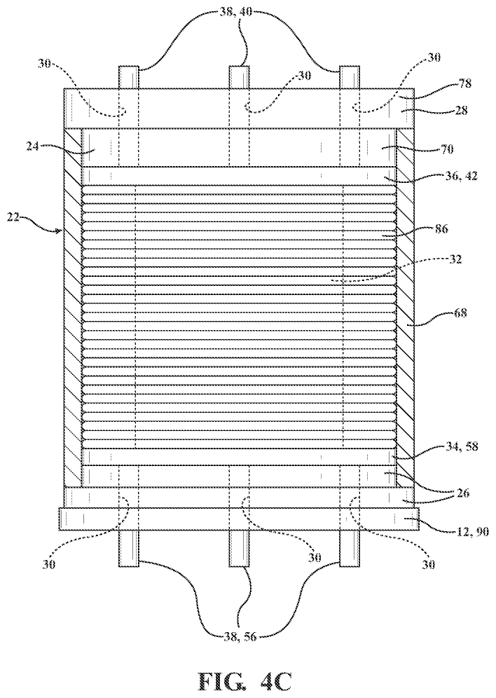

At least one protrusion 38 extends from at least one of the proximal and distal bobbin ends 34, 36 of the bobbin 32 and through the bore 30 to couple the bobbin 32 to the flux core 24. In other words, the at least one protrusion 38 can extend from only the proximal bobbin end 34 as shown in FIG. 4B, can extend only from the distal bobbin end 36 as shown in FIG. 4A, or can extend from both the proximal bobbin end 34 and the distal bobbin end 36 as shown in FIG. 4C.

In one embodiment, the at least one protrusion 38 is discrete from the bobbin 32. In another embodiment, the at least one protrusion 38 is formed integrally with the bobbin 32. In yet another embodiment, the at least one protrusion 38 is formed separately from the bobbin 32 and later joined with the bobbin 32 to become integral with the bobbin 32.

In some embodiments, as shown in FIG. 4A, the distal core end 28 of the flux core 24 defines the bore 30 and the at least one protrusion 38 is further defined as an at least one distal protrusion 40 extending from the distal bobbin end 36 of the bobbin 32. The bobbin 32 may have a distal shoulder portion 42 extending radially away from the axis A at the distal bobbin end 36, and the at least one distal protrusion 40 may extend from the distal shoulder portion 42 of the bobbin 32.

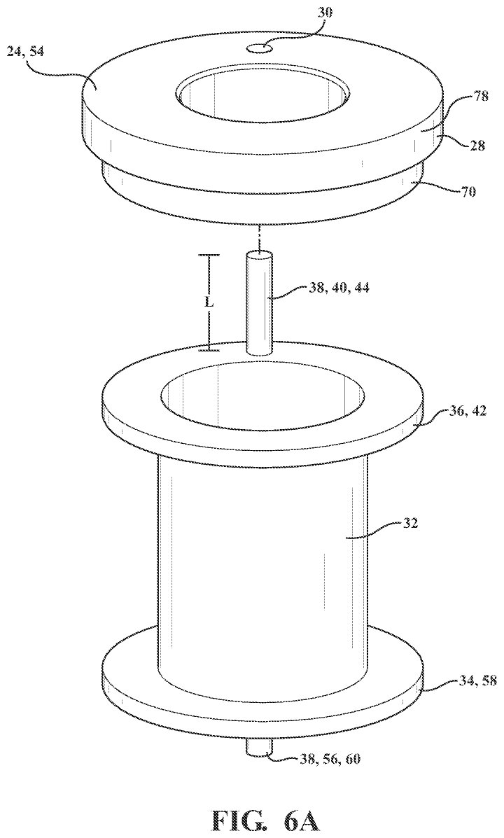

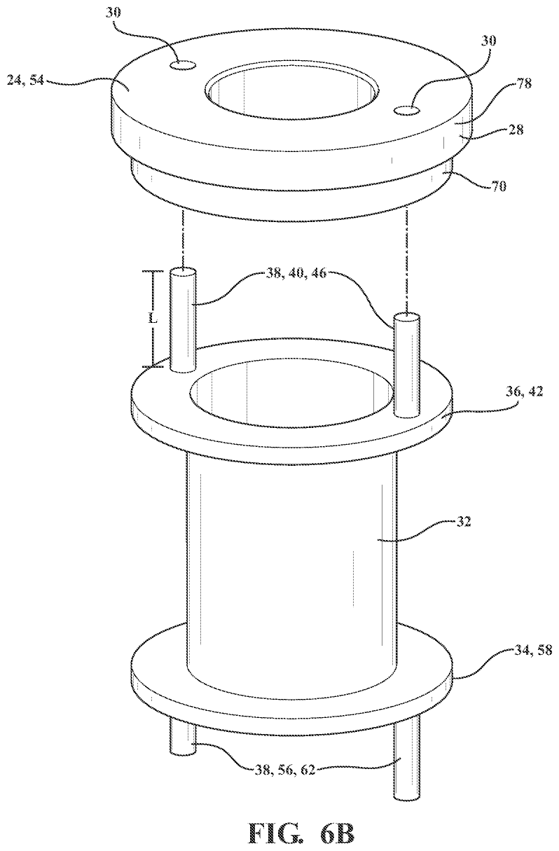

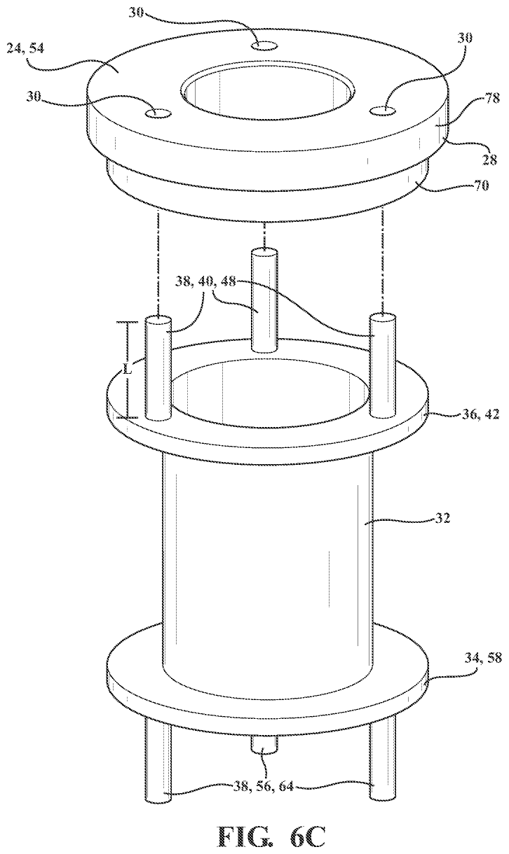

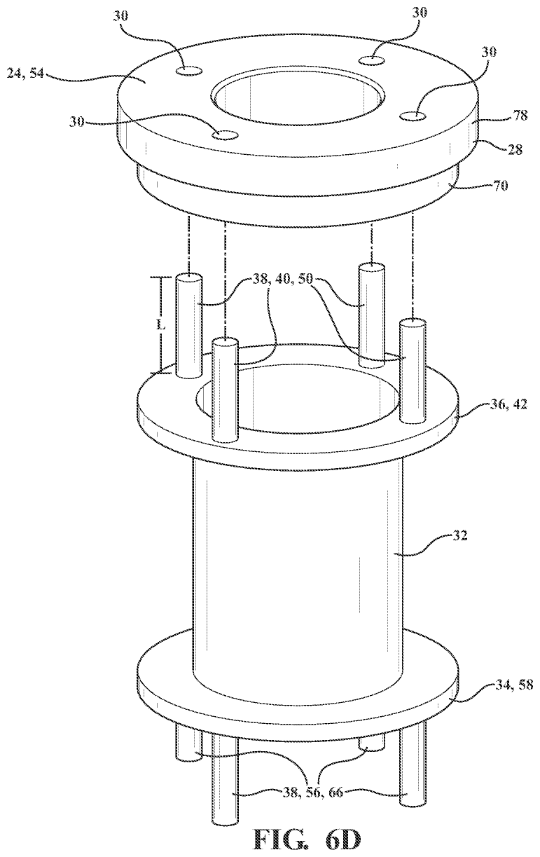

The at least one distal protrusion 40 may be further defined as either a single distal protrusion 44 as shown in FIG. 6A, two distal protrusions 46 as shown in FIG. 6B, three distal protrusions 48 as shown in FIG. 6C, four distal protrusions 50 as shown in FIG. 6D, or any other number “n” of distal protrusions. For each number “n” of distal protrusions 40, there may be an equal number “n” of bores 30 such that each distal protrusion 40 extends through one bore 30 of the flux core 24. The at least one distal protrusion 40 may be equally spaced circumferentially about the axis A. For example, in the embodiment where the at least one distal protrusion 40 is the two distal protrusions 46, the two distal protrusions 46 may be equally spaced circumferentially about the axis A by being spaced approximately 180 degrees apart from one another about the axis A. In the embodiment where the at least one distal protrusion 40 is the three distal protrusions 48, the three distal protrusions 48 may be equally spaced circumferentially about the axis A by being spaced approximately 120 degrees apart from one another about the axis A. In the embodiment where the at least one distal protrusion 40 is the four distal protrusions 50, the four distal protrusions 50 may be equally spaced circumferentially about the axis A by being spaced approximately 90 degrees apart from one another about the axis A. Similarly, for any other number “n” of distal protrusions, the any other number “n” of distal protrusions may be equally spaced circumferentially about the axis A by being spaced approximately 360/n degrees apart from one another.

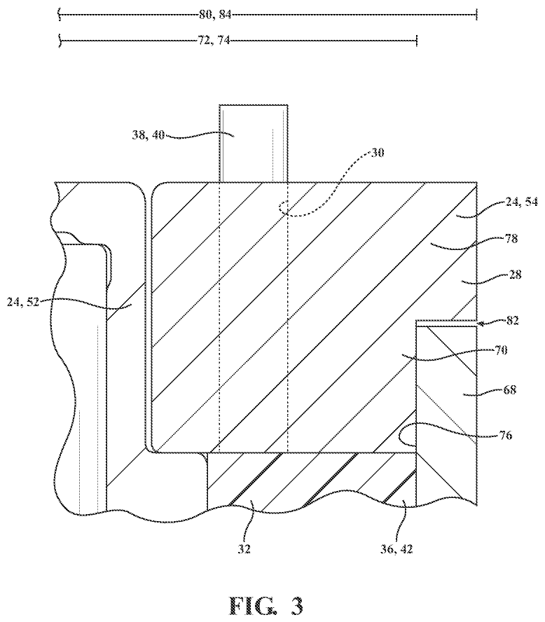

In one embodiment, as shown in FIGS. 2B and 3, the flux core 24 comprises a base portion 52 and a flux washer 54 discrete from the base portion 52 at the distal core end 28. In other words, the base portion 52 and the flux washer 54 may not be formed integrally with one another, but may instead be formed physically separate from each other. In the embodiment with the flux washer 54, the flux washer 54 of the flux core 24 defines the bore 30, and the at least one distal protrusion 40 extends from the distal bobbin end 36 of the bobbin 32 through the bore 30 of the flux washer 54.

In some embodiments, as shown in FIG. 4B, the proximal core end 26 of the flux core 24 defines the bore 30 and the at least one protrusion 38 is further defined as an at least one proximal protrusion 56 extending from the proximal core end 26 of the bobbin 32. The bobbin 32 may have a proximal shoulder portion 58 extending radially away from the axis A at the proximal bobbin end 34, and the at least one proximal protrusion 56 may extend from the proximal shoulder portion 58 of the bobbin 32.

The at least one proximal protrusion 56 may be further defined as either a single proximal protrusion 60 as shown in FIG. 6A, two proximal protrusions 62 as shown in FIG. 6B, three proximal protrusions 64 as shown in FIG. 6C, four proximal protrusions 66 as shown in FIG. 6D, or any other number “n” of proximal protrusions. For each number “n” of proximal protrusions 56, there may be an equal number “n” of bores 30 such that each proximal protrusion 56 extends through one bore 30 of the flux core 24. The at least one proximal protrusion 56 may be equally spaced circumferentially about the axis A. For example, in the embodiment where the at least one proximal protrusion 56 is the two proximal protrusions 62, the two proximal protrusions 62 may be equally spaced circumferentially about the axis A by being spaced approximately 180 degrees apart from one another about the axis A. In the embodiment where the at least one proximal protrusion 56 is the three proximal protrusions 64, the three proximal protrusions 64 may be equally spaced circumferentially about the axis A by being spaced approximately 120 degrees apart from one another about the axis A. In the embodiment where the at least one proximal protrusion 56 is the four proximal protrusions 66, the four proximal protrusions 66 may be equally spaced circumferentially about the axis A by being spaced approximately 90 degrees apart from one another about the axis A. Similarly, for any other number “n” of proximal protrusions, the any other number “n” of proximal protrusions may be equally spaced circumferentially about the axis A by being spaced approximately 360/n degrees apart from one another.

With reference to FIGS. 1-2B and 4C, in embodiments where both the at least one distal and proximal protrusions 40, 56 are present, the solenoid actuator 22, and thus the solenoid valve 10, may be completely assembled without requiring use of any crimping whatsoever. This advantageously results in quicker and more efficient assembly of the solenoid valve 10.

The solenoid actuator 22 further comprises a housing 68 disposed along the axis A such that the housing 68 at least partially surrounds the bobbin 32, as shown in FIGS. 1-2B and 4A-4C. The housing 68 may totally surround the bobbin 32 such that the housing 68 circumscribes the bobbin 32 around the axis A, or may only partially surround the bobbin 32 such that the housing 68 only partially circumscribes the bobbin 32 around the axis A. The housing 68 may also totally axially surround the bobbin 32 along the axis A, or may only partially axially surround the bobbin 32 along the axis A.

In some embodiments, as shown in FIGS. 2A-3, the distal core end 28 of the flux core 24 has a first portion 70 adjacent to and contacting the distal bobbin end 36 of the bobbin 32 and having a first diameter 72. The housing 68 has an inner diameter 74 approximately equal to the first diameter 72 of the first portion 70 of the distal core end 28 such that an interference fit 76 is established between the flux core 24 and the housing 68 at the distal core end 28. The difference required to establish the interference fit 76 is dependent on, among other factors, the materials of the bobbin 32 and the housing 68, on the manufacturing tolerances of the bobbin 32 and the housing 68, on the angle of taper of either the bobbin 32 and/or the housing 68, if any, and on the friction present between the bobbin 32 and the housing 68. It is to be appreciated that one of ordinary skill in the art will readily know the difference required to establish the interference fit 76.

In the embodiments where the flux core 24 comprises the base portion 52 and the flux washer 54 discrete from the base portion 52 at the distal core end 28, the flux washer 54 has the first portion 70 of the distal core end 28. In these embodiments, the first portion 70 of the flux washer 54 has the first diameter 72 and the housing 68 has the inner diameter 74 approximately equal to the first diameter 72 of the first portion 70 such that the interference fit 76 is established between the flux washer 54 and the housing 68 at the distal core end 28, as shown in FIGS. 2B and 3.

With reference to FIGS. 2A-3, the distal core end 28 of the flux core 24 may have a second portion 78 extending from the first portion 70 along the axis A and having a second diameter 80 larger than the first diameter 72 of the first portion 70. The first portion 70 of the distal core end 28 of the flux core 24 may extend axially beyond the housing 68 such that the second portion 78 of the distal core end 28 of the flux core 24 and the housing 68 define a gap 82 therebetween. In other words, the second portion 78 may be spaced from the housing 68 along the axis A and the second diameter 80 of the second portion 78 may be approximately equal to an outer diameter 84 of the housing 68 such that the second portion 78 of the distal core end 28 of the flux core 24 and the housing 68 define the gap 82 therebetween.

In the embodiments where the flux core 24 comprises the base portion 52 and the flux washer 54 discrete from the base portion 52 at the distal core end 28, the flux washer 54 has the second portion 78 of the distal core end 28, as shown in FIGS. 2B and 3. In these embodiments, the second portion 78 of the flux washer 54 has the second diameter 80 larger than the first diameter 72 of the first portion 70. The first portion 70 of the flux washer 54 may extend axially beyond the housing 68 such that the second portion 78 of the flux washer 54 and the housing 68 define the gap 82 therebetween. In other words, the second portion 78 may be spaced from the housing 68 along the axis A, and the second diameter 80 of the second portion 78 may be approximately equal to the outer diameter 84 of the housing 68 such that the second portion 78 of the flux washer 54 and the housing 68 define the gap 82 therebetween.

The gap 82 defined between the second portion 78 of the distal core end 28 of the flux core 24 and the housing 68 lowers the required tolerances of the base portion 52 and the flux washer 54 in the flux core 24. The gap 82 allows less precise tolerances of the first portion 70 and the second portion 78 along the axis A because the gap 82 between the second portion 78 and the housing 68 accommodates the variances during manufacturing in the first and second portions 70, 78 and in the housing 68. In other words, due to the variances during manufacturing, the first or second portions 70, 78 or the housing may extend farther along the axis A or may extend less far along the axis A as compared to the set dimensions of the first and second portions 70, 78 and the housing 68. However, the gap 82 allows these variances along the axis A to be accounted for, with the gap 82 becoming either larger or smaller, depending on the variances in either the first and second portions 70, 78 or the housing 68.

The gap 82 also ensures contact between the first portion 70 of the flux washer 54 and the base portion 52 necessary to complete a path of magnetic flux, or flux path, required to move the valve member 20 during energization of a coil 86, as shown in FIG. 2B. More specifically, the gap 82 allows the first portion 70 of the flux washer 54 to sit against the base portion 52 of the flux washer 54 while preventing the second portion 78 of the flux washer 54 from sitting against the housing 68.

In some embodiments, as shown in FIGS. 2A and 2B, the valve body 12 defines a valve bore 88, and the at least one protrusion 38 extends through the valve bore 88 of the valve body 12 to couple the bobbin 32 to the valve body 12. In one embodiment, the at least one protrusion 38 extending through the valve bore 88 is the at least one proximal protrusion 56. In another embodiment, the at least one protrusion 38 extending through the valve bore 88 is the three proximal protrusions 64. The valve body 12 may have a valve flange 90 extending radially away from the axis A, and the valve flange 90 may define the valve bore 88. In one embodiment, the valve flange 90 is formed integrally with the valve body 12. In another embodiment, the valve flange 90 is discrete from the valve body 12. In yet another embodiment, the valve flange 90 is formed separately from the valve body 12 and later joined with the valve body 12 to become integral with the valve body 12.

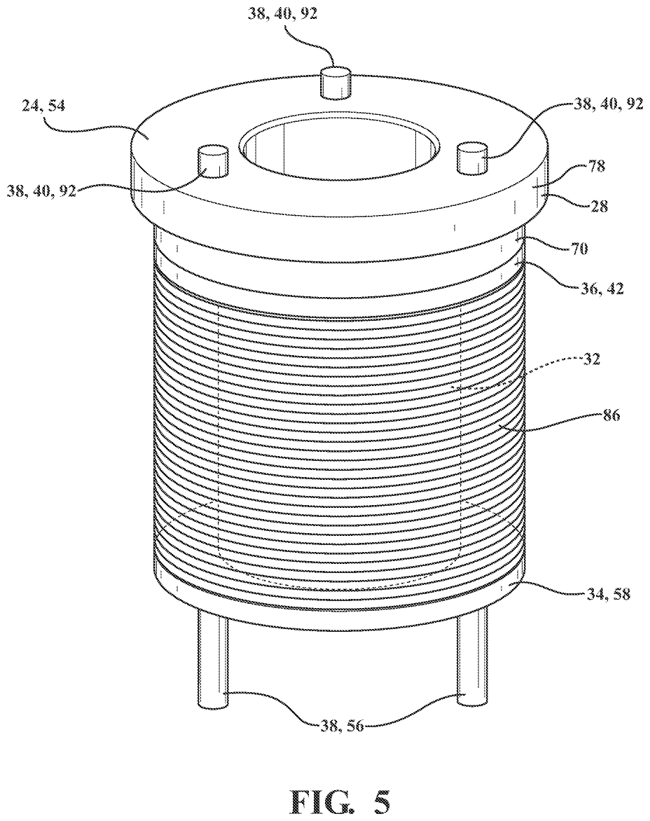

The at least one protrusion 38 may have a variety of geometries. With reference to FIG. 6A-6D, in one embodiment, the at least one protrusion 38 may have a cross-section that extends uniformly along a length L of the at least one protrusion 38. In another embodiment, the cross-section of the at least one protrusion 38 may vary along the length L of the at least one protrusion 38. In other words, the cross-section of the at least one protrusion 38 may taper while extending from the bobbin 32 or may expand while extending from the bobbin 32. In this embodiment, the at least one protrusion 38 may be substantially conical. In one embodiment, the cross-section of the at least one protrusion 38 is polygonal such as triangular, rectangular, or pentagonal, hexagonal, heptagonal, or octagonal. In the embodiment where the cross-section of the at least one protrusion 38 is polygonal, such as rectangular, the cross-section need not be perfectly polygonal, and thus not be perfectly rectangular. The cross-section of the at least one protrusion 38 may be substantially rectangular, for example. In another embodiment, the at least one protrusion 38 is further defined as an at least one post 92 having a substantially cylindrical configuration, as shown in FIG. 5. The at least one post 92 having a substantially cylindrical configuration has a cross-section that may be completely circular, may be oval, may be rounded having curved edges, or may be polygonal such as hexagonal, heptagonal, or octagonal

The at least one protrusion 38 may comprise a plastic, a composite such as a glass fiber reinforced plastic, or any polymer material capable of undergoing plastic deformation during assembly of the solenoid actuator 22. The material of the at least one protrusion 38 may be chosen by one skilled in the art based on factors including, but not limited to, the tensile strength of the material, the Young's modulus of elasticity of the material, the melting point of the material, and the glass transition temperature of the material. Although not required, the at least one protrusion 38 is typically solid completely therethrough. Preferably, the at least one protrusion 38 comprises the same material as the bobbin 32.

The length L of the at least one protrusion 38 may be between 2 millimeters and 3 inches (76.2 millimeters), as shown in FIGS. 6A-6D. This length L is only exemplary. The length L of the at least one protrusion 38 could even fall outside of this range. In other words, the length L also may be less than 2 millimeters or may be more than 3 inches (76.2 millimeters). Factors which influence the length L of the at least one protrusion 38 include, but are not limited to, the size of the solenoid actuator 22, the size of the flux core 24 or flux washer 54, and the size of the valve body 12. The at least one proximal protrusion 56 and the at least one distal protrusion 40 may have the same length L. However, in one embodiment, the at least one proximal protrusion 56 and the at least one distal protrusion 40 may have different lengths L. The at least one protrusion 38 may extend at least 2 millimeters axially beyond the at least one of the proximal and distal core ends 26, 28. Of course, it is to be appreciated that the at least one protrusion 38 may not extend axially beyond the at least one of the proximal and distal core ends 26, 28 in some instances. In the embodiments where the at least one protrusion 38 does not extend axially beyond the at least one of the proximal and distal core ends 26, 28, an additional plastic component such as a nut could be inserted into the bore 30 to extend the length L of the at least one protrusion 38 to couple the bobbin 32 to the flux core 24.

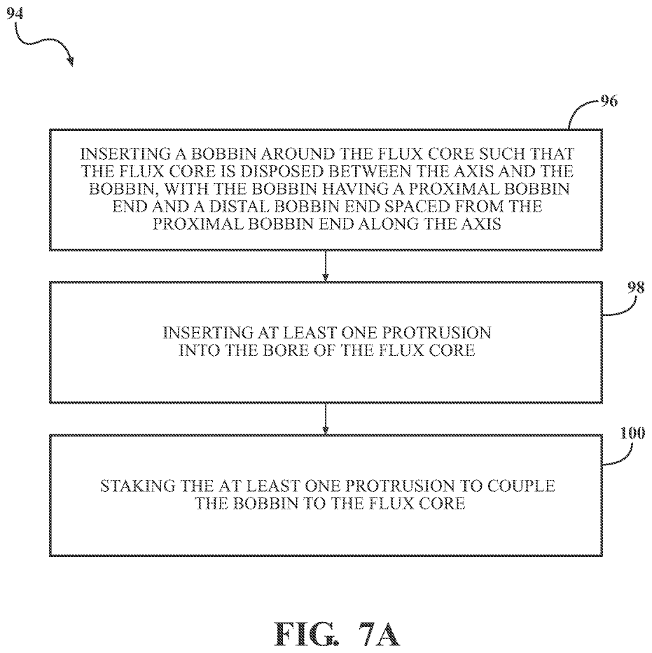

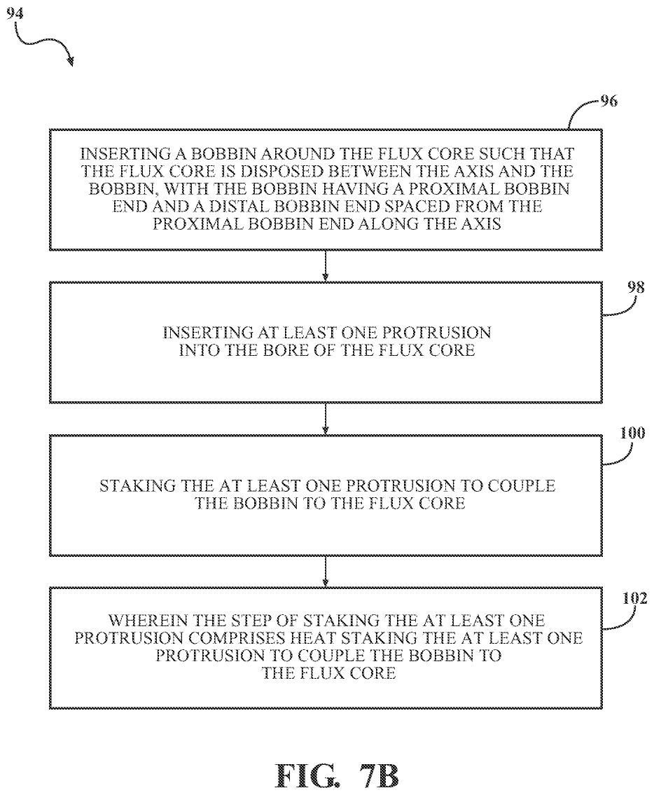

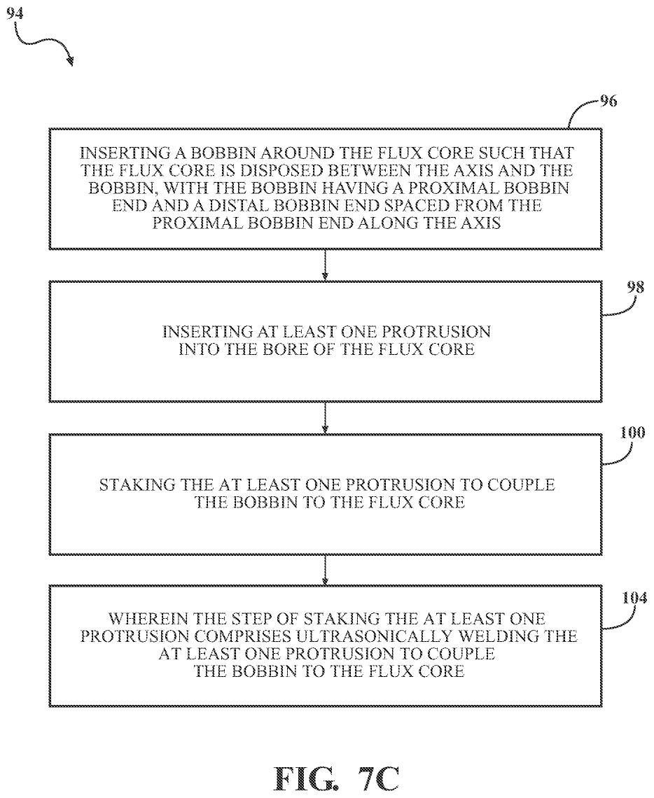

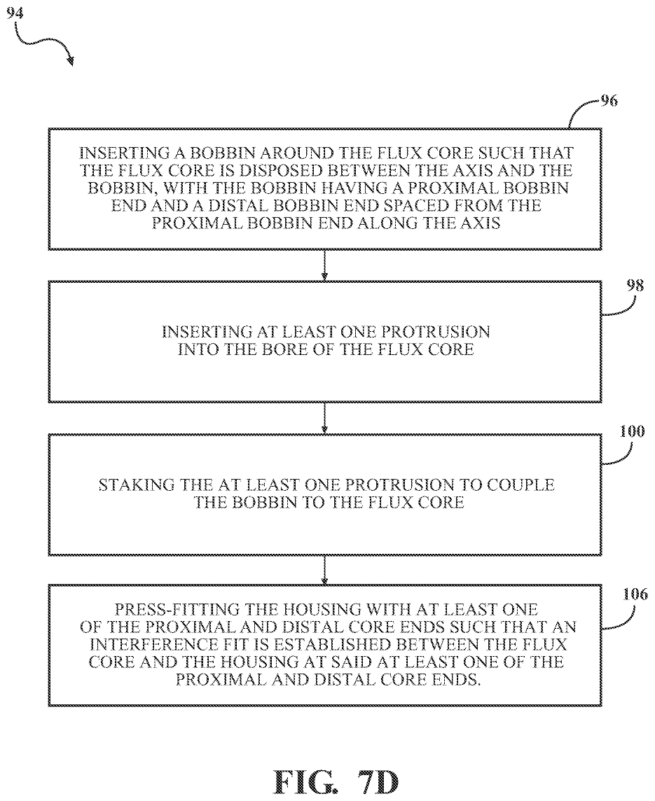

With reference to FIGS. 7A-7D, a method 94 of forming the solenoid actuator 22 for the solenoid valve 10 includes the step of inserting the bobbin 32 around the flux core 24 such that the flux core 24 is disposed between the axis A and the bobbin 32, as indicated by block 96. The method 94 further includes the step of inserting the at least one protrusion 38 into the bore 30 of the flux core 24, as indicated by block 98. The method 94 additionally includes the step of staking the at least one protrusion 38 to couple the bobbin 32 to the flux core 24, as indicated by block 100.

The step of staking 100 the at least one protrusion 38 may be done through a variety of techniques. One of ordinary skill in the art will readily appreciate that staking may be accomplished through heat staking, ultrasonic welding, cold forming, or any process that plastically deforms the at least one protrusion 38 to mechanically lock the at least one protrusion 38, and thus the bobbin 32, to the flux core 24. Staking 100 advantageously results in quicker manufacturing of the solenoid valve 10, easier joinder of dissimilar materials in the solenoid valve 10, and less expensive manufacturing costs of the solenoid valve 10 as compared to crimping processes previously known to assemble the solenoid valve 10.

More specifically, the crimping process requires the use of an expensive crimping machine having a pneumatic, hydraulic, or electromechanical press configured to pinch or compress a portion of the housing 68 near at least one of the proximal and distal core ends 26, 28 to mechanically lock the bobbin 32 to the flux core 24. The crimping process bends the portion of the housing 68 around the flux core 24 to mechanically lock the bobbin 32 to the flux core 24 indirectly. This crimping process is time consuming and is thus expensive, as an operator can only assemble a limited number of solenoid valves 10 in a set period of time. This crimping process is also limited to joining components with similar materials. The housing 68 and the flux core 24, for instance, typically both comprise a metallic material such that the crimping process is able to bend the portion of the housing 68 around the flux core 24 without damaging either the housing 68 or the flux core 24. However, because the bobbin 32 may comprise the plastic, composite, or polymer material, the crimping process would be unable to join and mechanically lock the bobbin 32 to the flux core 24 directly without causing damage to the bobbin 32 would be damaged during the crimping process.

The step of staking 100, however, results in more advantageous assembly of the solenoid valve 10 as compared to the crimping process described above. More specifically, the step of staking 100 requires a staking machine configured to stake the at least one protrusion 38 near at least one of the proximal and distal core ends 26, 28 to mechanically lock the bobbin 32 to the flux core 24 directly. This step of staking 100 is quicker than the crimping process, and is thus less expensive, as the operator can assemble a higher number of solenoid valves 10 in the set period of time. The step of staking 100 also advantageously allows the bobbin 32 to be directly joined to the flux core 24 despite the bobbin 32 comprising the plastic, composite, or polymer material and the flux core 24 comprising the metallic material.

In one embodiment, as discussed above, the step of staking 100 the at least one protrusion 38 comprises heat staking the at least one protrusion 38 to couple the bobbin 32 to the flux core 24, as indicated by block 102 in FIG. 7B. Heat staking involves using the staking machine having a source of heat and pressure to plastically deform the at least one protrusion 38. The source of heat and pressure may be a heated thermal tip configured to contact the at least one protrusion 38. One of ordinary skill in the art would know a temperature, a pressure, and an application time period of the source of heat and pressure appropriate to heat stake the at least one protrusion 38.

In another embodiment, as discussed above, the step of staking 100 the at least one protrusion 38 comprises ultrasonically welding the at least one protrusion 38 to couple the bobbin 32 to the flux core 24, as indicated by block 104 in FIG. 7C. Ultrasonic welding involves using the staking machine having a source of ultrasonic energy to plastically deform the at least one protrusion 38. The source of ultrasonic energy may be a vibrating horn configured to contact the at least one protrusion 38. One of ordinary skill in the art would know a frequency, a pressure, and an application time period of the source of ultrasonic energy appropriate to ultrasonically weld the at least one protrusion 38. In the embodiment where the at least one protrusion 38 does not extend axially beyond the at least one of the proximal and distal core ends 26, 28, the additional plastic component such as the nut may be inserted into the bore 30 and ultrasonically welded to the at least one protrusion 38 to couple the bobbin 32 to the flux core 24.

The step of staking 100, including the embodiment utilizing the step of heat staking 102, as shown in FIG. 7B, results in the plastic deformation of the at least one protrusion 38. This plastic deformation may result in shortening the length L of the at least one protrusion 38 while simultaneously increasing the width of the at least one protrusion 38. The plastic deformation of the at least one protrusion 38 may result in the at least one protrusion 38 having a mushroom shape with a round head; a riveted shape with a brazier head, a universal head, a counter-sunk head, a knurled head, or a flat heat; or a split shape with a rosette head, a flared head, or a hollow head.

The step of staking 100 eliminates the need for other more costly, less efficient, and more complex processes used to join the bobbin 32 to the flux core 24. Specifically, the step of staking 100 eliminates the need for the crimping processes used on the housing 68 to mechanically lock the bobbin 32 to the flux core 24. Crimping the housing 68 may disadvantageously result in small gaps between the base portion 52 and flux washer 54 in the flux core 24 that break contact between the base portion 52 and the flux washer 54. More specifically, these small gaps may result from distortion and buckling that occurs radially away from the axis A during the crimping process. Contact between the base portion 52 and the flux washer 54 in the flux core 24, however, is necessary to complete the path of magnetic flux, or the flux path, required to move the valve member 20 during energization of the coil 86.

In addition to the above benefits, the step of staking 100 the at least one protrusion 38 also requires less precise tolerances required of components in the solenoid valve 10 and allows more manufacturing flexibility during assembly of the solenoid valve 10. More specifically, the step of staking 100 the at least one protrusion 38 greatly decreases the likelihood of small gaps forming between the base portion 52 and the flux washer 54, and thus allows contact between the base portion 52 and the flux washer 54 in the flux core 24 necessary to complete the path of magnetic flux. Due to the decreased likelihood of small gaps forming, both the base portion 52 and the flux washer 54 in the flux core 24 do not require as precise tolerances to ensure contact between the base portion 52 and the flux washer 54.

Tolerances of the base portion 52 and the flux washer 54 in the flux core 24, as well as of the housing 68, often compound and accumulate to detrimentally “stack up”, thus achieving undesirable variances in the solenoid valve 10. The step of staking 100 the at least one protrusion 38 alleviates this “stack up” problem by reducing the number of tolerances that have an effect on the variances of the solenoid valve 10 once assembled. More specifically, the tolerances of the first and second portions 70, 78 and the housing 68 in the direction along the axis A may have a larger range of acceptable values, thus reducing the number of tolerances that have an effect on the variances of the solenoid valve 10 once assembled, as the tolerances of the first and second portions 70, 78 and the housing 68 in the direction along the axis A have a limited effect on the variances of the solenoid valve 10 once assembled.

The method 94 may further include a step of press fitting the housing 68 with at least one of the proximal and distal core ends 26, 28 such that the interference fit 76 is established between the flux core 24 and the housing 68 at the at least one of the proximal and distal core ends 26, 28, as indicated by block 106 in FIG. 7D.

The step of press fitting 106 the housing 68 with the distal core end 28 such that the interference fit 76 is established between the flux core 24 and the housing 68 at the distal core end 28 results in contact between the first portion 70 of the flux washer 54 and the base portion 52 of the flux core 24, thus completing the path of magnetic flux, or the flux path. The step of press fitting 106 the housing 68 with the proximal core end 26 such that the interference fit 76 is established between the flux core 24 and the housing 68 at the proximal core end 26 results in contact between the flux core 24 and the housing 68, thus completing the path of magnetic flux, or the flux path.

It is to be appreciated that various components of the solenoid valve 10 and dimensions of the various components of the solenoid valve 10 are merely illustrative and may not be drawn to scale. The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A solenoid valve comprising:
a valve body extending along an axis between a first end and a second end spaced from said first end along said axis and defining a fluid passage;
a valve member disposed at least partially in said fluid passage for controlling a flow of hydraulic fluid; and
a solenoid actuator extending along said axis and coupled to said valve body, with said solenoid actuator comprising;
a flux core extending along said axis, with said flux core having a proximal core end adjacent to said valve body and a distal core end spaced from said proximal core end along said axis such that said proximal core end is disposed between said valve body and said distal core end along said axis, and with at least one of said proximal and distal core ends defining a bore,
a bobbin extending along said axis such that said flux core is disposed between said axis and said bobbin, with said bobbin having a proximal bobbin end adjacent to said valve body and a distal bobbin end spaced from said proximal bobbin end along said axis such that said proximal bobbin end is disposed between said valve body and said distal bobbin end along said axis, and
at least one protrusion extending from at least one of said proximal and distal bobbin ends of said bobbin and through said bore to couple said bobbin to said flux core.

2. The solenoid valve as set forth in claim 1, wherein said distal core end of said flux core defines said bore and said at least one protrusion is further defined as an at least one distal protrusion extending from said distal bobbin end of said bobbin.

3. The solenoid valve as set forth in claim 2, wherein said bobbin has a distal shoulder portion extending radially away from said axis at said distal bobbin end, and wherein said at least one distal protrusion extends from said distal shoulder portion of said bobbin.

4. The solenoid valve as set forth in claim 2, wherein said at least one distal protrusion is further defined as three distal protrusions.

5. The solenoid valve as set forth in claim 4, wherein said three distal protrusions are equally spaced circumferentially about said axis.

6. The solenoid valve as set forth in claim 2, wherein said flux core comprises a base portion and a flux washer discrete from said base portion at said distal core end and defining said bore, and wherein said at least one distal protrusion extends from said distal bobbin end of said bobbin through said bore of said flux washer.

7. The solenoid valve as set forth in claim 1, wherein said proximal core end of said flux core defines said bore and said at least one protrusion is further defined as an at least one proximal protrusion extending from said proximal bobbin end of said bobbin.

8. The solenoid valve as set forth in claim 7, wherein said bobbin has a proximal shoulder portion extending radially away from said axis at said proximal bobbin end, and wherein said at least one proximal protrusion extends from said proximal shoulder portion of said bobbin.

9. The solenoid valve as set forth in claim 7, wherein said at least one proximal protrusion is further defined as three proximal protrusions.

10. The solenoid valve as set forth in claim 9, wherein said three proximal protrusions are equally spaced circumferentially about said axis.

11. The solenoid valve as set forth in claim 1 further comprising a housing disposed along said axis such that said housing at least partially surrounds said bobbin, wherein said distal core end of said flux core has a first portion adjacent to and contacting said distal bobbin end of said bobbin and having a first diameter, and wherein said housing has an inner diameter approximately equal to said first diameter of said first portion of said distal core end such that an interference fit is established between said flux core and said housing at said distal core end.

12. The solenoid valve as set forth in claim 11, wherein said flux core comprises a base portion and a flux washer discrete from said base portion at said distal core end, with said flux washer having said first portion such that an interference fit is established between said flux washer and said housing at said distal core end.

13. The solenoid valve as set forth in claim 11, wherein said distal core end of said flux core has a second portion extending from said first portion along said axis and having a second diameter larger than said first diameter of said first portion, and wherein said first portion of said distal core end of said flux core extends axially beyond said housing such that said second portion of said distal core end of said flux core and said housing define a gap therebetween.

14. The solenoid valve as set forth in claim 1, wherein said valve body defines a valve bore, and wherein said at least one protrusion extends through said valve bore of said valve body to couple said bobbin to said valve body.

15. The solenoid valve as set forth in claim 1, wherein said at least one protrusion is further defined as an at least one post having a substantially cylindrical configuration.

16. The solenoid valve as set forth in claim 1, wherein said at least one protrusion has a length between 2 millimeters and 3 inches.

17. The solenoid valve as set forth in claim 1, wherein said at least one protrusion extends at least 2 millimeters axially beyond said at least one of said proximal and distal core ends.

18. A solenoid actuator for a solenoid valve, said solenoid actuator comprising:
a flux core extending along an axis between a proximal core end and a distal core end spaced from said proximal core end along said axis, with at least one of said proximal and distal core ends defining a bore;
a bobbin extending along said axis such that said flux core is disposed between said axis and said bobbin, with said bobbin having a proximal bobbin end and a distal bobbin end spaced from said proximal bobbin end along said axis; and
at least one protrusion extending from said at least one of said proximal and distal bobbin ends of said bobbin and through said bore to couple said bobbin to said flux core.

19. A method of forming a solenoid actuator for a solenoid valve, with the solenoid actuator comprising a flux core extending along an axis between a proximal core end and a distal core end spaced from the proximal core end along the axis, with at least one of the proximal and distal core ends defining a bore, said method comprising the steps of:
inserting a bobbin around the flux core such that the flux core is disposed between the axis and the bobbin, with the bobbin having a proximal bobbin end and a distal bobbin end spaced from the proximal bobbin end along the axis,
inserting at least one protrusion into the bore of the flux core, and
staking the at least one protrusion to couple the bobbin to the flux core.

20. The method as set forth in claim 19, wherein the step of staking the at least one protrusion comprises heat staking or ultrasonically welding the at least one protrusion to couple the bobbin to the flux core.
